(19) United States
(12) Patent Application Publication
(10) Pub. No.: US 2002/0052881 A1
(43) Pub. Date: May 2, 2002

(54) Method for online advertising and compilation of demographic data

(75) Inventor: Zen Player, San Rafael, CA (US)

Correspondence Address: PILLSBURY WINTHROP LLP, DOCKET/CALENDAR DEPARTMENT, 50 FREMONT STREET, SAN FRANCISCO, CA, 94105-2230, US

(73) Assignee: GAME COMMANDERS LIMITED

(21) Appl. No.: 09/863,011

(22) Filed: May 22, 2001

Related U.S. Application Data
(60) Provisional application No. 60/206,189, filed on May 22, 2000.

(51) Int. Cl. G06F 7/00

(52) U.S. Cl. 707/104.1

(57) ABSTRACT

Demographic data is collected from the actions of a player playing a game. By playing the game on the internet, the manpower required to collect the data is reduced. By utilizing an interesting game, the level of participation resistance is reduced. In addition, the present invention also focuses audience attention to sponsored advertising.

### RELATED APPLICATION

The present application claims priority from U.S. Provisional Application Ser. No. 60/206,189 filed on May 22, 2000 for Method and Program for Online Advertising and Compilation of Demographics.

### BACKGROUND OF THE INVENTION

1. Field of the Invention

The present invention relates to online advertising and the collection of data and, more particularly, to a method for online advertising and compilation of demographic data.

2. Description of the Related Art

In the marketplace, it is a common practice for companies to develop specific products for specific demographic groups. One aspect of this development is the determination of the likes and dislikes of the targeted demographic group. In addition to determining the likes and dislikes, understanding the reasons behind these likes and dislikes can substantially increase the likelihood that the company will have a successful product launch.

There are a number of approaches that companies often use to determine the likes and dislikes, along with the underlying reasons for the likes and dislikes, of the members of the targeted demographic group. Some of these approaches include, for example, focus groups, questionnaires, and surveys.

One drawback to these conventional approaches is that they are typically manpower intensive. For example, in a focus group setting, one researcher may work with a relatively small number of participants for an extended period of time. Thus, to gather a statistically meaningful amount of data, a number of researchers and a significant period of time are required. Questionnaires and surveys are frequently used in public settings, such as shopping malls, but it is often difficult for one researcher to work with more than a small number of people at one time.

Another drawback to these conventional approaches is that there is typically a significant amount of resistance to participation. Due to the larger time commitment that is required of many of the participants, focus groups provide nominal compensation to the participants in some cases to attract customer participation. Even with these inducements it is often difficult to get participants.

It is also difficult to get individuals who are willing to participate in but the shortest and simplest of questionnaires and surveys. As a result, it is difficult to obtain much insight into the likes and dislikes of the participants with questionnaires, and even more difficult to obtain much insight into the reasons for the likes and dislikes.

One approach to reducing the manpower requirement is to use on-line questionnaires and surveys. On-line questionnaires and surveys have the advantages of reaching a substantially larger audience and requiring only routine web-site maintenance (after initial set up), but suffer from a number of disadvantages.

One of the problems with on-line questionnaires is that, just like questionnaires presented in other settings, it is difficult to get individuals to take time to respond. To attract web traffic, web sites have, with limited success, offered incentives ranging from nominal compensation, such as coupons and discounts, to daily, weekly, or monthly drawings of cash or merchandise.

In addition to the difficulty in attracting participants, on-line questionnaire sites must also establish a web presence that is distinctive enough, or otherwise identifiable, so that those who wish to participate can find the web site to participate. Establishing a web presence among the millions of web pages that are available, however, is not an insignificant task.

Thus, there is a need for a method of collecting demographic data that reduces the necessary manpower, increases the depth of information that can be obtained about the likes and dislikes of the participants, and reduces the level of participation resistance.

### SUMMARY OF THE INVENTION

The present invention provides a method for collecting demographic data that reduces the manpower required to collect the data, increases the depth of information that is obtained about the likes and dislikes of the participants, and reduces the level of participation resistance. In addition, the present invention also focuses audience attention to sponsored advertising.

The method of the present invention includes the steps of logging on a player to a game, and detecting a play request after the player has logged on. The method further includes the step of transmitting first game information to the player and receiving second game information from the player. The first game information allows the player to play the game, while the second game information represents a number of actions taken by the player during the game.

The method of the present invention also includes the steps of providing a number of points to the player based on the actions taken by the player, and collecting demographic data from the actions taken by the player.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block-diagram illustrating a computer 100 in accordance with the present invention.

FIG. 2 is a flow chart illustrating a method 200 of obtaining demographic data in accordance with the present invention.

FIG. 3 is a screen print version of an embodiment of a HyperStation game interface 300 in accordance with the present invention.

FIG. 4 is a flow chart illustrating a method 400 in accordance with the present invention.

### DETAILED DESCRIPTION

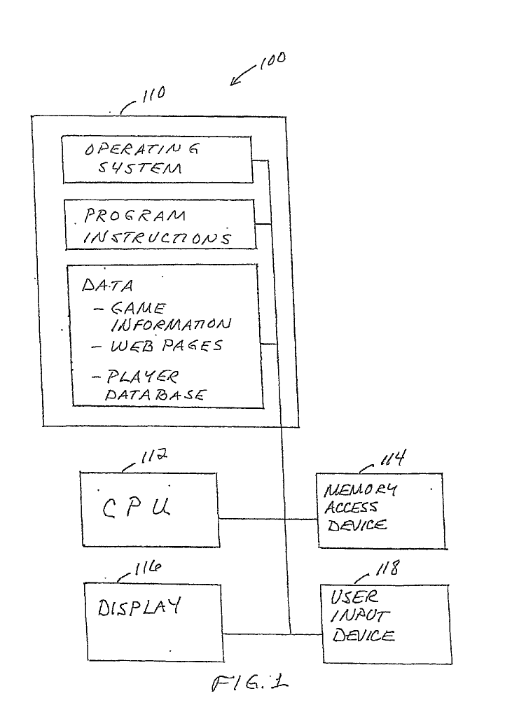

FIG. 1 shows a block-diagram that illustrates a computer 100 in accordance with the present invention. As described in greater detail below, the present invention provides a game to a game player. In addition, the present invention collects demographic data in response to actions taken by the player while playing the game, and provides advertising to the player during the game.

As shown in FIG. 1, computer 100, which can be implemented with an IIS server, includes a memory 110 that has an operating system block that stores an operating system, a program instruction block that stores program instructions, and a data block that stores data. The data block, in turn, includes game information, a number of web pages, and a database that stores player information.

As further shown in FIG. 1, computer 100 includes a central processing unit (CPU) 112 that is connected to memory 110, and a memory access device 114, such as a disk drive or a networking card, that is connected to memory 110 and CPU 112. CPU 112 executes the program instructions using the data. Memory access device 114 allows the program instructions to be transferred to memory 110 from an external medium, such as a disk or a networked computer. In addition, device 114 allows information in memory 110 or CPU 112 to be transferred to the external medium.

Computer 100 further includes a display system 116 that is connected to CPU 112. Display system 116 displays images to the user, which are necessary for the user to interact with the program. Computer 100 also includes a user-input device 118, such as a keyboard and a pointing device, which is connected to CPU 112. The user operates input device 118 to interact with the program. Computer 100, absent the program and data files of the present invention, is conventional.

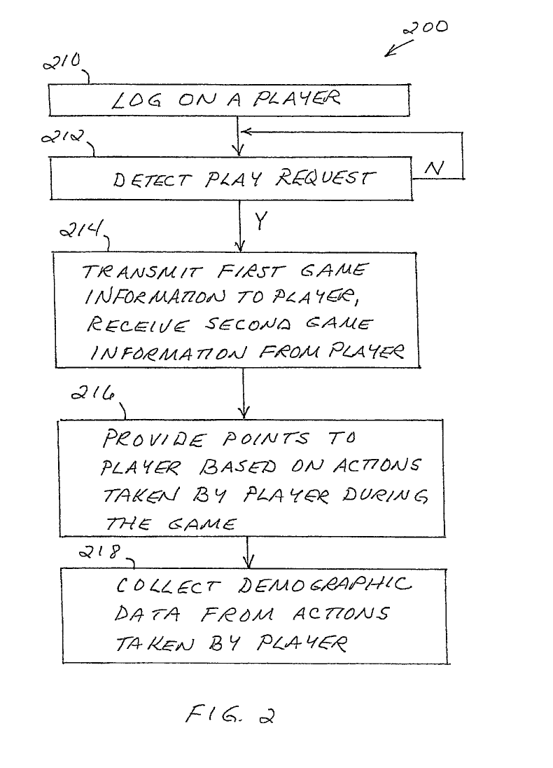

FIG. 2 shows a flow chart that illustrates a method 200 of obtaining demographic data in accordance with the present invention. Method 200 is implemented in software that is programmed into computer 100. As shown in FIG. 2, method 200 begins at step 210 by logging on a player. The log on process in step 210, in turn, depends on whether the player is playing for a first or a subsequent time.

When playing for the first time, the present invention includes a set-up step that loads background information onto the player's computer so that the player can play the game. The background information includes program and data files that are necessary to set up the game environment on the player's computer.

The program files include an installer program, a registration program, a game program, supporting programs such as DirectX TM, Quicktime TM, and a web browser (Netscape TM or Explorer TM). The data files, in turn, include movies. In one embodiment, the background information is provided to the player via a CD-ROM that stores the background information. When the background information is stored on a CD-ROM, the player inserts the CD-ROM in a CD-ROM readable drive.

When the CD-ROM is inserted for the first time, the installer program auto runs and installs a number of items to the local hard drive of the player. The items include all files from the CD-ROM except movies and installer files, the supporting programs such as DirectX TM, Quicktime TM, and the web browser (Netscape TM or Explorer TM). (After the install a restart may be required, depending upon the system. Subsequent running of the CD-ROM requires the player to load the CD-ROM & trigger the auto run, or if the CD-ROM is already loaded, click/select the icon/menu item created by the installation.) The set up step also registers the player. In one embodiment, the first time the HyperDisk is run after installation, the player sees an exciting thematic animation sequence that leads to a 360° Virtual Reality (VR) environment branded with, for example, a band's look and feel. Within this environment is seen a floating cube (the HyperCube) which is a 3D navigational button created using, for example, Director software.

This item is ‘static’ when viewed in the regular VR mode, but when it is zoomed up to, it activates into a dynamic object, and may be turned to reveal all sides by using the mouse or arrow keys. Even though other functions may be indicated, upon first-time insertion, the only active button is a Registration (symbol ‘R’) button. After this sequence and initial player registration, the HyperCube will feature six fully functional buttons in this mode.

Upon pressing the ‘R’ button, a registration process occurs where relevant information about the player is gathered. As part of the registration process, the player must input the following information: real name, delivery address (for prizes and other material items), e-mail and phone details, log-in name (called a PlayName) and password.

In addition, the registration process requires that the player type in a code (a 20+ alpha-numeric sequence). Each disc is individually coded (such code being printed in a “tamper-proof” manner on a CD sleeve, included in the packaging). The sleeve solution described pertains to New Zealand retail requirements. Typically, CDs are removed from jewel-cases and stored behind a retail counter, while the COVERS of each sku's are displayed. When the customer brings the case to the checkout counter, the retailer hands over a sleeve with the HyperDisc inside.

The printed registration number has a scratch-off coating or a peel-off foil, both of which will clearly indicate if product has been tampered with. In the USA and other retail environments, the (sealed) CD product will contain the registration number printed on the material inside the jewel-case, still with the tamper-proof aspects described.

The registration program sends player parameters to computer 100 (the IIS server). To ensure security of each disc and prevent piracy, only bonafide registration numbers are accepted by the server. If launch of a pirated disc is attempted with a false registration number, or the same registration number is detected for more than one disc, the system will provide access to the first (original) disc entry, and deliver a message to others indicating that access is denied. Further, a message will be delivered indicating that the player should contact a help-desk (by email or phone).

The server then generates an Active Server Page (ASP) to receive parameters and enters them into the database. All data is submitted to the database in computer 100 via a standard dial-up ISP connection. The PlayName and password may be in part provided by the server (method 200 running on computer 100), and require the player to add to the content. For example, a player may submit “Batman” and Hypertainment adds “1234” for a total login name/password of “Batman1234”. Other versions may exist. Computer 100 (the server) substitutes each valid registration number plus login/password combination (see above) for a code, which is impossible to detect or duplicate. The player never sees this code.

Once an alphanumeric code on the server is allocated, it cannot be altered, and from that point on the server will (internally) identify players by this code alone. Upon subsequent purchases, the server will recognize the registrants' details, and offer an “express registration” option for immediate code-allocation. This will speed up the players' overall experience.

The database, which contains a corresponding number of unique 20 alphanumeric codes, is structured on a per-product basis. That is, if a Hypertainment release is 50,000 units, this many codes are provided, if 1 million units, 1 million codes, etc. Each registration number printed on the packaging is ALSO resident on the server, and is recognized when player types it in.

The present invention uses a security technology to track and record sequential alpha-numeric codes from point of sale (bar-code scan in-store) through the installation process (at home), including optional CPU serial number, name, email address, product registration number. As described in greater detail below, the security technology allows access to a Hypertainment web site where entertaining games may be engaged.

Registration starts a permanent record in the database in computer 100 (on the server) for each player's personal information, ongoing dreamographic data, prize selection, game progress and dynamic scoring details. In one embodiment, the games include a number of questions. Each player has an entry in the database for every question of every game where their answers and explanations are stored for later analysis and Dreamographic reporting.

When playing for other than the first time, the player simply enters their PlayName and password to access the Hypertainment System. Once registration is complete for a first time player, the player is brought back to the HyperCube, to choose from all active buttons.

The active buttons include: 1) HyperGames, 2) videos, 3) tutorial, 4) prizes, 5) news, and 6) community. When buttons 1, 2 or 3 are pressed, the game program presents the Game Interface (HyperStation) or a modified video-screen for viewing and playing of games. Tutorials also occur through this interface. If buttons 3 through 6 are pressed, the system automatically dials up the Hypertainment web site and opens a browser window at the specific site page requested.

When HyperGames is selected, the selection causes a brief animation sequence to transition the player from the Shihad VR environment to a game interface. There is an intro-screen with the following choices offered: HyperGame 1 (My Mind Sedate), HyperGame 2 (The General Electric), and HyperGame 3 (B.D.O with SHIHAD).

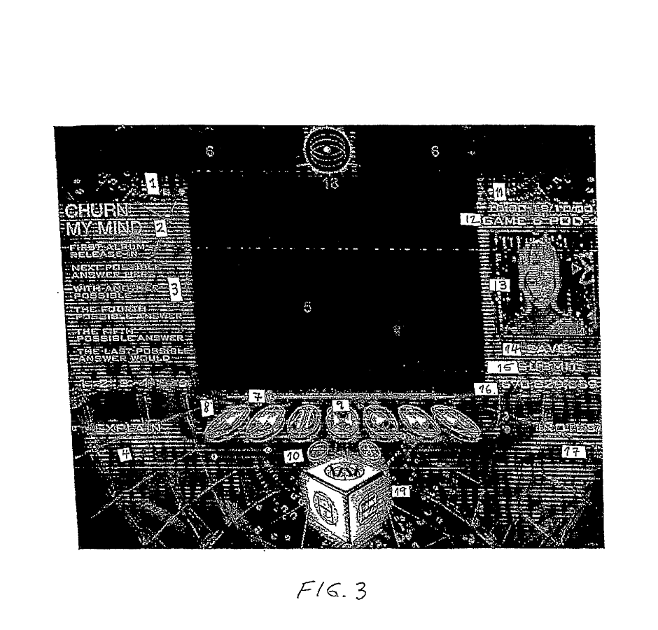

When a HyperGame is selected (say Game 1), the HyperStation game interface appears. The HyperStation is a virtual control panel and video-monitor screen area. All functions are operable, have sound FX and optional rollover voice descriptions. FIG. 3 shows a screen print version of an embodiment of a HyperStation game interface 300 in accordance with the present invention.

As shown in FIG. 3, interface 300, which area is animated and triggers various sound FX, includes a HyperClue display 2 where questions are downloaded to the player's system in various ways, and a Multichoice Answer display 3 where either the number or text may be selected. Interface 300 further includes an Explanation Area 4 where the player may type a brief explanation to win extra points, and a PlaySceen 5 where HyperGame Videos and other messages are displayed.

Interface 300 additionally includes a Sponsor-Banner area 6 where advertising can be downloaded from computer 100 and displayed. These may change hourly or daily, and comprise dynamic game elements. Interface 300 further includes a TimeCounter 7 which monitors progress through HyperGames, or references a clue in sequence.

Game Controls 8 are used to move through the HyperGame in various speeds, pause or find clues. In addition, interface 300 includes a HyperLog 9 for storing clues to access later. Works together with Time Code for clue reference. Further, interface 300 includes Volume Control 10 that moves the volume up and down, and a Time and Date display 11 that displays in 24 hr format and “MetaBeats” (branded Internet time).

Interface 300 also includes a Game-Round/Clue display 12 that changes and updates as games are played, and a HyperGuide 13. The image in HyperGuide 13 is pressed to hear a voice-over, or silence it. A Save Command 14 is used to save answers or games for submission at a later time.

Further, interface 300 includes a Score Display 15 for displaying MetaPoints, and a Notes Area 16 where data or reminders may be typed in for game-play. Used with HyperLog control. MetaPoints are the currency of the HyperRealm, and may be traded for prizes. Interface 300 additionally includes a HyperGram 17 that shows a diagrammatic view of the HyperRealm, the origin of all Hypertainment content.

Returning to FIG. 2, once the log in is complete, method 200 moves to step 212 to detect a play request. When a player presses “PLAY”, the screen displays an animated type image indicating that “your questions are being downloaded now”. Other messages are displayed on the screen at various times.

Once the play request has been received, method 200 moves to step 214 to transmit first game information to the player and receive second game information from the player. The first game information allows the player to play the game, while the second game information represents a number of actions taken by the player during the game.

The total information required to play the game includes the background information and the first game information. While the background information includes program and data files that are necessary to set up the game environment on the player's computer, the first game information includes data files that are necessary to play the game in the game environment. The first game information is provided to the player via a downloaded from computer 100.

Thus, when the player begins a round of a game, the game program can connect to computer 100 (the HyperServer) to download the questions and answers for that round. A message may appear in the game-screen area indicating “now accessing HyperClues”. Other elements may animate. The game program sends a set of parameters to computer 100 whereupon an Active Server Page (ASP) is generated on computer 100 (the IIS server) and the data is returned to the game program.

Once this is done the video appears and is ready to play. The PLAY button activates the video, and the player may view the imagery in various speeds (frame-by-frame, regular, fast forward/rewind). In addition, a ‘Log’ button may be pressed to ‘bookmark’ the frame or time code of the video. This information may be used to play the game, e.g., to answer various questions.

In one embodiment, each game may consist of 8 rounds of 6 questions, making a total of 48 questions to answer for each game. All questions and corresponding answers are resident on computer 100, and are delivered to the player's hard-drive upon request. These questions display on the “HyperClue” area 2 of the interface (see FIG. 3) in a multi-choice sequence. Further, each question may be converted into a cryptic format, to make the question itself part of the game-solving experience. (See notes below on “HyperClue Grid” for making up questions.)

For example, a question regarding the band's FIRST TOUR appears. The full question may be: What was the date of the first ever Shihad appearance in 1996 in Europe, and where was it? This data is converted to a cryptic HyperClue format, such as “Euro First” with a selection of SIX answers, all appearing below the question.

After reviewing each answer, and perhaps researching the Shihad website and other sources to check their selection, the player presses either the TEXT element in the answers or the NUMBER of the answer. In either case, the corresponding element highlights to confirm selection.

At this point, a voice-over prompt may announce a warning (in HyperGuide mode) that “once an answer is selected to save or submit, this question is not available to play again”. The SUBMIT and SAVE buttons illuminate, the player elects to save or submit an answer, and the next question appears. Additional questions and answers may be downloaded from computer 100 via the net with no time limitation, as long as the structure follows the HyperClue grid sequence. This will benefit sponsors who come along later.

In one embodiment of the invention, the questions may typically be in one of the following formats: 1) Video related where visual and text clues are digitally integrated into the music-video footage; 2) Web research where information to answer correctly is found in one or more (band/sponsor etc) website; 3) Dreamographic which includes a brief “explanation” as to why the player thinks this is the correct answer (fuzzy).

Video related questions require the player to examine the video for something (an object/word) hidden, and select a multichoice answer. Some questions may require a typed explanation for the answer. Web research questions require the player to activate the web browser and seek out the information required for the multichoice answer. This information may pertain to the band, the music, or other artist element, or can relate to a product or service sponsored in this game. Again some questions may require a typed explanation for the answer.

Dreamographic questions are purely a typed response stored on computer 100 for sponsor, advertiser and internal information. The system can detect if someone is NOT entering correct English and store this information for future manual (or automated) analysis, compilation and report-generation.

Alternately, the program may be able to read, analyze and otherwise interpret text-input answers using meta-tag technology. This is where various words pertaining to the correct answer are programmed into the system, and correlate with the words typed in. A high percentage of word-matches constitutes a correct answer.

Prior to answering any questions, the player may browse through the six questions for that round with next and previous buttons, the answers are selected/deselected with a click. The “Explanation” area activates for text input on various questions. This information is described above under “Dreamographic” type questions. If no text response is required, this area remains inactive.

If a question appears requiring web-based answers, the HyperCube will highlight the “W” facet to indicate that the browser is activated. Clicking the HyperCube will dial the internet and link to a web page from computer 100 (the Hypertainment server). In this scenario, this would be the Shihad HyperSite home page, where players would see an option called “clues & cues”.

Upon clicking this, an HTML text area appears indicating how to search for clues. This may require travelling to the Shihad.com site, a sponsor's site or other designated areas to find clues to answer questions. A “return to HyperGame” button on the Shihad.com site will automatically close the browser and reveal the HyperStation interface. Otherwise, the player may simply close or quit the browser in the standard manner to return. In many cases, switching between browser and game applications will allow for clue research, and will be totally compatible.

The HyperCube navigation button will display three options while playing all HyperGames. These are Help (H), Web (W) and Exit (E). The player may press each one to be linked to the appropriate region or function. If the player wishes to leave the game before a round (six questions) is finished, or their most recent answers have not been saved/submitted, a VO (voice over) warns “if you exit the game at this time, you will forfeit points for this round. Please complete this round, then exit the HyperGame”. If the player disregards this warning and exits the game, the player forfeits the points for that round. If the player completes the game/round, points may be awarded, and the player can then leave the game interface.

Referring again to FIG. 2, once the first game information has been transmitted to the player and the second game information has been received from the player, method 200 moves to step 216 to provide a number of points to the player based on the actions taken by the player during the game.

In a preferred embodiment of the above example of the invention, each question is assigned a certain amount of points, depending upon the level of difficulty or other aspects that can be earned for answering. Questions requiring an explanation will score half the points for the correct multichoice, and the balance for the explanation. Limited checks on the explanation are made to insure that the explanation is not garbage. If it is determined to be garbage, no extra points are provided. However, even if the multi-choice answer is incorrect the player can still earn half the points for a valid response.

Continuing with the above example, when all six questions for a round have been answered, the player is presented with the option to “Submit” to computer 100 (the HyperCore Server) or “Save” for later submission. If submitted, the program checks the questions and answers while delivering a (VO and graphic) message stating “The HyperCore is checking you answers please wait”. Points earned are displayed and added up in an animation sequence, and the data is sent to computer 100 (the Server) to be added to the players points stored in the database.

This is achieved via ASPs being generated on the fly by computer 100 (the IIS server). If saved, or if connection to computer 100 via the internet is delayed, the answers and explanations for the round are saved to the player's hard drive and submitted at the next opportunity. As the game program has to connect to the internet/HyperServer to begin each round of each game, the saved submission will only have to be stored until the player plays again. This also eliminates having to save more than one submission at a time.

Once a round of questions has been answered and saved or submitted, those questions and answers become “locked off” preventing any further access by the player. To further discourage fraudulent activity, all “correct” answers are provided at the end of the campaign period. In the meantime, players can still earn MetaPoints for their answers, but are kept in some level of mystery until ALL games have been played, won or otherwise expired.

At this point, the player may then press “E” to exit or “W” to visit the website. In the case of Exit, the HyperStation interface changes back to the original SHIHAD Pod VR area, where the HyperCube may be viewed for more options. If the player presses E again (for Exit), a VO asks if the player is sure they want to leave. If they press the E button AGAIN on the HyperCube, an exit sequence (animated or other) plays and the screen goes black. The player then sees credits, or may bypass these by simply clicking on the screen. At this point, the player is returned to their desktop.

If a player goes to the website, a variety of services are provided. A specially branded SHIHAD area (on Hypertainment.com) included news and updates on the band, tour info, clues and cues on the HyperGames, chat areas, “life-style” articles, web-cast functions, retail information, merchandise for sale, a Prize Catalog, and other areas. Players can access their “account” of points won that day or session, and may visit the Prize Catalog to select most desired items to trade points for. Prizes are displayed in full-color jpegs, with brief descriptions and a MetaPoint VALUE.

In one embodiment, MetaPoints are equated with “real dollars” in the actual world, in the following values: 1) 10,000 MetaPoints=$1 (country of origin currency); 2) 100,000 MetaPoints=$10; 3) 1,000,000 MetaPoints=$100; and 4) 100,000,000 MetaPoints=$10000. The MetaPoint System currently counts up to 999 Million points (equivalent to almost $100,000).

This will be achieved by running a reporting program such as Crystal Reports running queries over the SQL server data, which dynamically tallies and displays points to login/password players only. These points will decrease upon the player selecting the prize desired, checking that stock is available, locating the nearest pickup point (or indicating a delivery preference), and confirming the item.

When the player selects a prize from the Hypertainment.com website, the player is given details of where the player can redeem the prize (a local retail or warehouse etc). Several other details are displayed to the player on the web page which they can print out, or if they don't have a printer they can write them down. They include their CD-Key registration number, login name/password, real name and prize details. There may be a SKU (merchandising item) number for tracking and inventory control.

Upon visiting the retailer where the prize is waiting, and presenting their winner documentation, the retailer phones a hotline to give the operator details provided by the player. The operator checks the players' prize details against the entry created in the Hyperserver database and confirms if it all data matches. If the retailer has the prize item in stock, he tells the operator who then logs in the database that the prize has been collected with time/date stamp, winner details and other security information.

A standard Owners Agreement containing all standard details of liability, copyright and player responsibility is presented to the player as part of the registration process. A simple “Agree/Disagree” option button is pressed to continue, or “Request Support” may take them to a FAQ list to address their need. In addition, a “Consumer Advocacy” statement assures players that their personal data is kept confidential will not be transferred for any reason. A help-desk contact is listed.

Returning to FIG. 2, after a number of points have been provided to the player, method 200 moves to step 218 to collect demographic data from the actions taken by the player. In the present invention, a psycho-demographic research system structures questions (to the player) in such a way as to encourage the player to respond with non-empirical data about a ‘fantasy’ individual who the player would LIKE to be known as in the game (Hypertainment) environment. The information collected is stored digitally and measured against the player's play habits, prize choices, other “fuzzy data” compiled by similar players, sponsors' market research, most common scenarios, and the player.

Continuing with the above example, during each play sequence, data is dynamically composed over-against play patterns. For example, a male player aged 16 yrs who has identified a certain “fantasy profile” will still play game interactions in a particular manner, with particular speed and acuity, at certain times of day or night, etc. Though there will be a broad array of patterns, certain paradigms can be seen to reinforce or diverge from previously entered information about the player's fantasy character.

This information may then be compiled, packaged and delivered (in electronic or hardcopy form) to paying sponsors or interested companies without invasion of the players' privacy. The personal data (name, address, phone, age, etc) of each player along with Dreamographic data is preferably never disclosed to any party for any reason.

This approach to research and it's collection technology correlates with complex anthropological studies conducted in UC Berkeley (University of Berkeley in California) during the 1990's which measured individuals' descriptions of themselves with factual data, reporting a less-than 10% divergence factor. That is, of all people profiled, less than 10% submitted information diverging from “truthful”, and of these, the degree of exaggeration was approximated at 10% beyond the “truth”.

This factor is relatively easy to make allowances for in Dreamographic calculations, and even more importantly, it doesn't matter! What is of greatest importance is that players are WILLING to provide in-depth data on themselves (via a fantasy persona) which will determine the types of products and services most preferred, and WHY. This process constitutes a method of customer profiling that has been impossible via standard market-research methods (such as focus groups, surveys, online questionnaires, etc.) The above describe game requires the player to have a Pentium-200 MMX, with 32 MB RAM, 30 MB HDD space, Internet connection, Win95/98/2000, or a PowerPC Mac, 32 MB RAM, 30 MB HDD space, Internet connection, MacOS v8.1, or better.

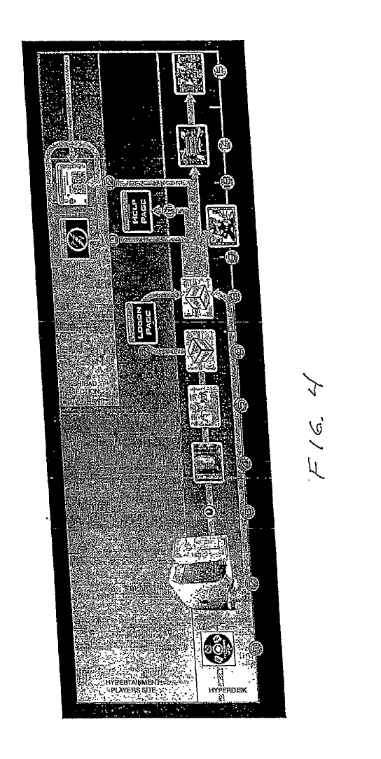

FIG. 4 shows a flow chart that illustrates a method 400 in accordance with the present invention. As shown in FIG. 4, method 400 begins at step 1 with an introduction. For example, the introduction can indicate “Congratulations on your purchase of the world's first HyperGameCD. Inside this package you'll find a Player Registration Card, with a tamper-proof coating for security purposes. Scratch off the silver coating and you'll find a Player Registration Number. Follow the instructions below to install and register. This disk is unique to you. No one else can use it. Any attempt to play pirated discs are detected by the HyperCore and denied access. This HyperGameCD is your key to the interactive HyperRealm, where games and clues are provided to help you win MetaPoints to trade for cool prizes. To play all HyperGames, your computer must be connected to the internet and your HyperGameCD must be inserted.” (IMAGE—CD Package.)

Next, method 400 moves to step 2 for an installation. For example, the installation can indicate “Insert the CD into your computer. It will automatically run an INSTALLER program to download all components onto your hard drive required to play HyperGames. This includes third party software such as QuickTime, Direct-X, plug-ins, and the latest web browser. It will also create an icon on your desktop for instant access.” (IMAGE—PC.)

Next, method 400 moves to step 3 to commence. For example, the commencement can indicate “When everything is installed, your computer will either restart automatically, or give you a message to restart. Once you have, the HyperGame ICON will appear on your desktop. If possible, turn your lights down, and reduce all distractions in your area. Check that your speaker volume is loud enough to hear all details in the adventure you're about to embark upon. Now double-click on this icon to begin the HyperGame experience. (IMAGE—Restart button.)

Next, method 400 moves to step 4 for initiation. For example, the initiation can indicate “You will meet Princess Halycia, fifth daughter of EON. She is your HyperGuide in this realm, and will explain various key procedures to you. In order to proceed, you must roll your cursor over her eyes and press one to make a choice. If you decide to proceed, you will be enveloped in a dimensional vortex, witness the creation of the HyperRealm, and journey inside to arrive at the Shihad Pod. Click your cursor on the Lightning Bolt to open the pod. Once inside, you may move around by click-dragging your cursor. Zoom in or out by using SHIFT, CONTROL or ALT keys. When you are ready to proceed, click on the HyperCube. This is your primary navigational device for all games, website and other special areas. To return to the pod VR, click OFF the HyperCube.” (IMAGE—Princess Eyes C/U.)

Next, method 400 moves to step 7 for registration. For example, the registration can indicate “Click the R symbol on the Hypercube. A registration form will appear. Enter your Player Registration Number (from inside CD packaging), including your name, address, phone #, etc. The primary purpose of this data is to open your personal HyperFile, and track prize delivery to your correct address. Please be accurate. Any errors could result in your prizes being delivered to someone else! Also, please read and fill out the consumer agreement. All personal information in your HyperFile is strictly confidential, and will not be released for any reason. When all data is correctly entered, press the SUBMIT button. Note: you only need to register once. After that, the HyperCore will permit access when you enter your HyperSona and PlayCode. (IMAGE—HyperCube C/U.)

Next, method 400 moves to step 8 for access. For example, the access can indicate “The HyperCore will now process your data and confirm that you are a registered Player. Use your ARROW keys to rotate the HyperCube and view all faces. Select an area by pressing on the specific cube face you require. The different glyphs indicate areas to access in the realm. “G” takes you directly to the GAME interface, or HyperStation. “V” refers to “VIDEOS”, viewed in optional sizes. “W” takes you to a special Shihad website, accessible only by registered Players. “P” takes you to the PRIZES page, a personal view of all current prizes available. Here you may select your favorite prizes, compile a “Dream List” of items to win, check your MetaPoint score, and trade points for prizes as soon as you have enough. “H” is the HELP command, offering Players various tips on how to play, navigate, score, and interact with others fans. Updated FAQ's and this schematic are also found there. “E” is to EXIT. This command is also found on the Game Interface, and exits you from the HyperRealm.” (PRIMARY IMAGE—HyperCube C/U, both sides, SECONDARY IMAGES—SHIHAD HOMEPAGE, PRIZE PG 12, VIDEO ONLY, HELP PG 11.)

Next, method 400 moves to step 14 for selection. For example, the selection can indicate “Here you may choose from three HyperGames, or an animated tutorial. When you select a HyperGame, an internet connection will be established, and all clues and questions for that game will download from the HyperCore. Note: You must maintain an Internet connection to receive HyperGame elements and submit answers. Caution: Any break in this connection during a round of play may disrupt your scoring potential. Please make every effort NOT to be interrupted! When you press TUTORIAL, you will see a hands-free demonstration of the HyperStation, with Princess Halycia offering useful instructions. You may return to this screen at any time during a game by pressing the HyperCube. (IMAGE—Game selection screen.)

Next, method 400 moves to step 15 for interaction. For example, the interaction can indicate “The HyperStation is the area where all video HyperGames are played. Your HyperClues and multi-choice questions appear on the left of the video, and may be answered in any order. To view an interactive tour of this area, press the “H” face of the HyperCube. Princess Halycia will provide voice-over descriptions of each aspect of the HyperStation, and offer general play instructions. When you wish to silence Princess Halycia, press the “H” on the HyperCube again. Each video features EIGHT rounds of questions, with SIX questions per round. You must select one of the SIX multi-choice answers to earn MetaPoints. You may click on numbers 1-6 to view all rounds of questions before answering. When you select an answer, it will highlight. You may change your answers as many times as you wish before submitting. Additional MetaPoints may be earned by providing a brief EXPLANATION of how you arrived at that answer. The HyperCore analyses key words, so please be precise with spelling, grammar, and spaces, etc. When you have made all final selections and have entered explanations, press the SUBMIT button to upload your answers. (IMAGE—HyperStation game interface.)

One option includes investigation. For example, the investigation can indicate “The HyperGame is ready to play when a video image appears on screen and the play-controls illuminate. Use the play-controls to start, pause, rewind, fast-forward, frame-advance and LOG time codes for clue-hunting. You may drag the TIME BAR to locate a specific point in the video. Watch the TIME CODE DISPLAY for video reference. In addition, you may press Volume-Up (+) or Volume-Down (−) to adjust the sound. View the videos, including individual frames, and become familiar with the music, lyrics and visual aspects. Read HyperClues and all questions, and watch for clues within the videos. The HyperClues are a cryptic form of each question. You may need to de-cipher the QUESTION first before you can answer it! Look for any symbols included in the questions. These could indicate WHERE to look for the answers. Clues and tips to solving these questions can be found on the HELP area of the Players website. Press W to access this from the HyperStation. (IMAGE—HyperStation C/U of controls and videoscreen (from HyperStation art).)

Another option includes submission. For example, the submission can indicate “Some answers will be found in the video clips played on your screen. Some answers will be found on various web sites. When you are ready to submit a round of selected answers, press SUBMIT on the HyperStation. Your answers are uploaded to the HyperCore, and a new updated score will be displayed. CAUTION: If you attempt to exit the HyperGame before completing all six questions in a round, Princess Halycia will issue a warning that you could forfeit that round. That is, failing to finish all six questions may result in losing ALL MetaPoints for that round. When you have completed and submitted any round, the next round will appear. If you wish to change games or exit, do so BEFORE you begin the next round. (IMAGE—HyperStation C/U of QUESTION AREA with bit of VIDEO SCREEN (from HyperStation art).)

A further option includes accumulation. For example, the accumulation can indicate “At the completion of each round, your new score will appear. These are your MetaPoints, or currency in the HyperRealm. At any time, you may go to the PRIZE CATALOGUE on the Players Website, and check up on available prizes. You can also place your favorite prizes in a “Dream List” of items you wish to win. Each prize displays a MetaPoint value and other details. When you have scored enough MetaPoints to trade for a prize, follow the instructions on the Prize page to receive that item. After the HyperCore has validated your request and checked on current inventory, you will receive notice that your prize will be delivered, and the expected delivery date. (IMAGE—HyperStation C/U of METAPOINTS and bit of SUBMIT button (from HyperStation art).)

An additional option includes absorption. For example, the absorption can indicate “Move between HyperGames and the Players Website as frequently as you like. Use the ALT+TAB command (PC) or click on programs to switch (Mac) between both. Spend as much time as you need to research and answer all questions accurately, however remember that prizes are limited, and are traded on a first-come, first-serve basis. It is recommended that you organize and systematize your answer strategy to respond as quickly as possible and win the best prizes while they are in stock. Total absorption in the HyperRealm can result in magnetizing unlimited opportunities! (IMAGE—HyperStation, full crop shot.)

Thus, a method and apparatus has been described for collecting demographic data. The method reduces the manpower required to collect the data, increases the depth of information that is obtained about the likes and dislikes of the participants, and reduces the level of participation resistance.

In addition, the present invention also focuses audience attention to sponsored advertising by delineating specific clues within a moving or still image (such as music video, CDROM, DVD or other), in a variety of modalities (visual, auditory, text-based or other) for the purposes of entertainment, education and game-playing, in part motivated by the potential of winning prizes provided by sponsors within an online environment.

It should be understood that various alternatives to the invention described herein may be employed in practicing the invention. Thus, it is intended that the following claims define the scope of the invention and that methods and structures within the scope of these claims and their equivalents be covered thereby.

What is claimed is:

1. A method of obtaining demographic data, the method comprising the steps of:
logging on a player to a game;
detecting a play request after the player has logged on;
transmitting first game information to the player and receiving second game information from the player, the first game information allowing the player to play the game, the second game information representing a number of actions taken by the player during the game;
providing a number of points to the player based on the actions taken by the player; and
collecting demographic data from the actions taken by the player.

2. The method of claim 1 wherein the player has a player computer and the player loads background information into the player computer from an external source, and the first game information into the player computer.

3. The method of claim 2 wherein the background information includes information necessary to run the game.

4. The method of claim 3 wherein the information includes a program for registering the game.

5. The method of claim 1 wherein the first game information includes a number of questions.

6. The method of claim 1 wherein the second game information includes a number of points.

7. The method of claim 6 wherein the points are stored in a player database.

8. The method of claim 1 wherein the demographic data includes sex data, age data, and patterns.

9. The method of claim 8 wherein the patterns include time of play data.

10. The method of claim 8 wherein the demographic data includes data provided by the player.

11. The method of claim 10 wherein the data provided by the player includes prize choices.

12. The method of claim 1 wherein the player identifies a fantasy persona that the player would like to be known as.

13. A method for focussing user attention on advertising, the method comprising:
delineating specific clues which require a user to search a moving or still image;
providing the clues to the user in a variety of modalities;
providing the moving or still image within an online environment;
encouraging the user to play by providing the opportunity to win prizes for correct answers; and,
incorporating sponsor advertising into any of the clues, the moving or still images and the prizes.

14. A demographic research system associated with a game comprising the steps of:
directing questions to a user in such a way that the user answers for a persona of their own invention;
collecting user responses to the questions;
measuring the collected responses against play patterns of the user; and,
compiling demographic data about the user.

15. The system of claim 14 wherein measured values result from the measuring step, and the demographic data includes the measured values.
